(19) United States
(12) Patent Application Publication
(10) Pub. No.: US 2026/0214169 A1
(43) Pub. Date: Jul. 23, 2026

(54) IMAGE INSPECTION SYSTEM, IMAGE INSPECTION APPARATUS, AND INSPECTION LEVEL SETTING SUPPORT METHOD

(71) Applicant: KONICA MINOLTA, INC., Tokyo (JP)

(72) Inventor: Kazuomi SAKATANI, Tokyo (JP)

(73) Assignee: KONICA MINOLTA, INC., Tokyo (JP)

(21) Appl. No.: 19/410,062

(22) Filed: Dec. 5, 2025

(30) Foreign Application Priority Data
Jan. 17, 2025 (JP) 2025-006702

(51) Int. Cl. H04N 1/00

(52) U.S. Cl. CPC H04N 1/00005; H04N 1/00037; H04N 1/00045; H04N 2201/0082

(57) ABSTRACT

An image inspection system includes an inspection level setting support mode in which a printed material which is a sheet on which a content has already been printed, set in a sheet feeder and fed from the sheet feeder is conveyed to the conveyance route, and the threshold value for the inspection level is set by detecting an image defect based on a first read image obtained by reading the printed material with an image reader in a state where printing operation of an image former is turned off.

### CROSS-REFERENCE TO RELATED APPLICATION

The entire disclosure of Japanese patent application No. 2025-006702, filed on Jan. 17, 2025, is incorporated herein by reference in its entirety.

### BACKGROUND OF THE INVENTION

### 1. Technical Field The present invention relates to an image inspection system, an image inspection apparatus, and an inspection level setting support method.

### 2. Description of Related Art

There has been an inspection technique in which an image formed on a recording material such as a sheet with an image forming apparatus is read with a reading device that is installed in the image forming apparatus and reads an image on a conveyed sheet, and the image is compared with a reference image to inspect the image.

An image inspection system disclosed in Japanese Unexamined Patent Publication No. 2014-044712 outputs an image obtained by adding simulated defects to an input image. Then, the technique is proposed in which a threshold value for determining a defect in a read image is determined based on a difference between a defect read image obtained by reading an output result and a master image serving as a reference generated from the input image.

### SUMMARY OF THE INVENTION

However, in the inspection technique disclosed in Japanese Unexamined Patent Publication No. 2014-044712, an image obtained by adding simulated stain or streak-like toner adhesion to input image data, is subjected to image processing and then printed. Thus, characteristics such as appearance and impression are slightly different from those of defects that actually occur, and an actual image defect may not be adequately reflected in a printed chart material for threshold value setting. The present invention has been made in consideration of the above-described circumstances, and an object of the present invention is to appropriately set an inspection level by setting a threshold value of an inspection level using a printed material in which a defect has actually occurred.

To achieve at least one of the abovementioned objects, according to an aspect of the present invention, a system reflecting one aspect of the present inventions comprises the followings.

An image inspection system including:
a sheet feeder;
an image former that forms an image on a sheet fed and conveyed from the sheet feeder; and
an image reader that is arranged downstream of the image former on a conveyance route along which the sheet is conveyed and reads the image on the sheet, wherein
the image inspection system detects an image defect using a threshold value for an inspection level set using a read image generated by reading with the image reader, and
the image inspection system includes an inspection level setting support mode in which a printed material which is a sheet on which a content has already been printed, set in the sheet feeder and fed from the sheet feeder is conveyed to the conveyance route, and the threshold value for the inspection level is set by detecting an image defect based on a first read image obtained by reading the printed material with the image reader in a state where printing operation of the image former is turned off.

### BRIEF DESCRIPTION OF THE DRAWINGS

Advantages and features provided by one or more embodiments of the present invention will be fully understood in conjunction with the following detailed description and the accompanying drawings. However, these are for purposes of illustration only and are not intended to limit the present invention.

FIG. 1 is a diagram illustrating a schematic configuration of an image inspection system 100 according to the present embodiment;

FIG. 2 is a block diagram illustrating a configuration of the image inspection system 100;

FIG. 3A to 3E are schematic diagrams for describing a printed material;

FIG. 4 is a flowchart illustrating processing in an inspection level setting support mode according to a first embodiment;

FIG. 5 is a subroutine flowchart illustrating processing in step S14;

FIG. 6A illustrates an example of an operation screen used in step S120;

FIG. 6B illustrates an example of an operation screen used in step S120;

FIG. 6C illustrates an example of an operation screen used in step S120;

FIG. 6D illustrates an example of an operation screen used in step S140;

FIG. 7 is a subroutine flowchart illustrating processing in step S19 according to the first embodiment;

FIG. 8A illustrates an example of an operation screen for setting inspection levels and checking a determination result with the inspection levels;

FIG. 8B illustrates an example of an operation screen for setting inspection levels and checking a determination result with the inspection levels;

FIG. 9 is a table indicating inspection level ranges indicating an example of types of image defects and setting items;

FIG. 10 is a flowchart illustrating image inspection processing performed using preset values set in the inspection level setting support mode;

FIG. 11A is a subroutine flowchart illustrating processing in step S19 according to a second embodiment;

FIG. 11B is a subroutine flowchart illustrating a partial modification example of FIG. 11A;

FIG. 12A illustrates an example of inspection result outputs presented to a user according to the second embodiment;

FIG. 12B illustrates an excerpt of some outputs from the outputs in FIG. 12A;

FIG. 13 is a flowchart illustrating processing in the inspection level setting support mode according to a third embodiment; and

FIG. 14 is a subroutine flowchart illustrating processing in step S21.

### DETAILED DESCRIPTION

Hereinafter, embodiments of the present invention will be described with reference to the accompanying drawings. However, the scope of the present invention is not limited to the disclosed embodiments. Note that in the description of the drawings, the same components are denoted by the same reference signs, and redundant descriptions are omitted. In addition, dimensional ratios in the drawings are exaggerated for convenience of description and may be different from actual ratios.

### (Overall Configuration of Image Inspection System 100)

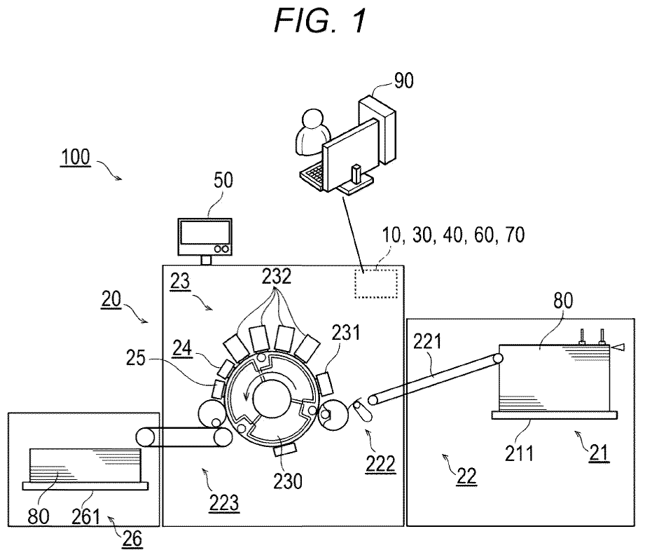

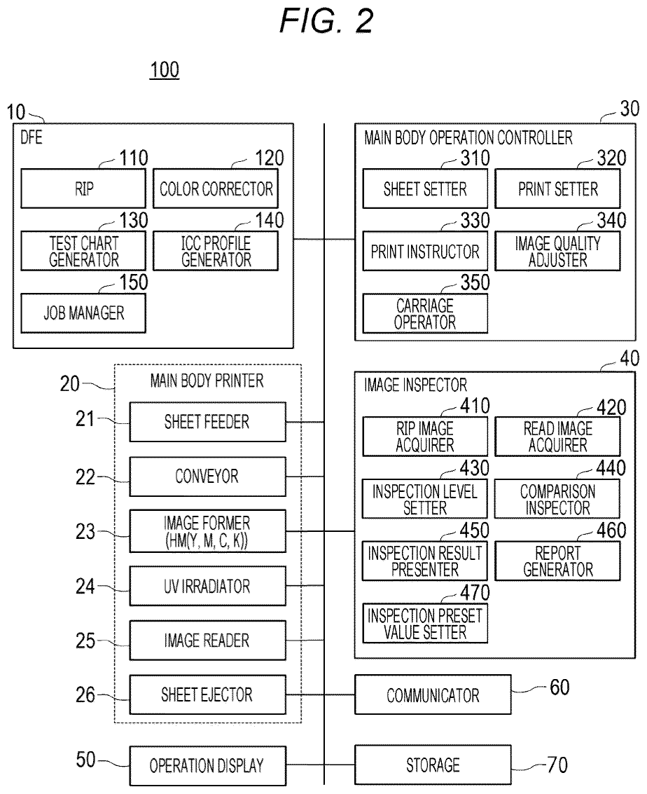

Hereinafter, the image inspection system 100 according to the present embodiment will be described with reference to FIGS. 1 and 2. FIG. 1 is a diagram illustrating a schematic configuration of the image inspection system 100, and FIG. 2 is a block diagram illustrating a configuration of the image inspection system.

The image inspection system 100 includes a digital front end (DFE) 10, a main body printer 20, a main body operation controller 30, an image inspector 40, an operation display 50, a communicator 60, a storage 70, and the like. These are connected to each other via a signal line.

The operation display 50 includes a touch screen, a numeric keypad, a start button, a stop button, and the like. The operation display 50 displays the status of the image inspection system 100, and is used for inputting various instructions from a user through functions of the main body operation controller 30. In the present embodiment, inspection levels are set by the user therethrough. In addition, the operation display 50 is used for presenting image inspection results to the user. The communicator 60 is an interface for communicating with other devices. The image inspection system 100 is communicably connected to a terminal device 90 via the communicator 60. The storage 70 stores various kinds of data. The storage 70 stores various job lists, threshold values for each of a plurality of levels for the inspection levels and preset values for the inspection levels (these will be described below).

The terminal device 90 is a personal computer (PC) and is operated by the user such as a manager or an operator who operates the image inspection system 100. The terminal device 90 may be used to present an inspection result to the user during execution of an inspection level setting support mode in the image inspection system 100. Note that the terminal device 90 may be included in the image inspection system 100.

The DFE 10 functions as a raster image processor (RIP) 110, a color corrector 120, a test chart generator 130, an ICC profile generator 140, and a JOB manager 150. The DFE 10 received print jobs from the terminal device 90 or the like via the communicator 60. The print jobs each include print data (hereinafter, also referred to as document image) and print settings. The job manager 150 manages the execution start, execution end, progress status, execution order, and the like of these print jobs. The RIP 110 performs rasterization processing for converting, based on print settings of the print job, the print data into bitmap data on a per-page basis. The ICC profile generator 140 generates color correction information related to an ICC profile standardized by the International Color Consortium (ICC), to enable consistent color reproduction across different devices. The color corrector 120 performs color correction based on the color correction information. The test chart generator 130 generates a test chart for calibration.

### (Main Body Printer 20)

The main body printer 20 includes a sheet feeder 21, a conveyor 22, an image former 23, a UV irradiator 24, an image reader 25, and a sheet ejector 26.

The sheet feeder 21 stores a plurality of sheets 80 to be used for image formation and feeds the sheets 80 one by one. The sheet feeder 21 includes a sheet feed tray 211. The sheet feed tray 211 is plate-shaped, on which one or more sheets 80 can be placed. The sheet feed tray 211 moves up and down according to the amount of sheets 80 placed thereon. The sheet feed tray 211 is held at a position where the topmost sheet 80 is conveyed by the conveyor 22.

The conveyor 22 includes a first conveyor 221, a handover section 222, and a second conveyor 223. The image former 23 includes an image forming drum 230, a sheet heater 231, and a plurality of head modules (HM) 232 corresponding to the respective colors of yellow (Y), magenta (M), cyan (C), and black (K). The image former 23 is an inkjet-method image former and is thus free from malfunctions when the printing operation is turned off. On the other hand, for example, in the electrophotographic method, an external additive included in toner functions as a lubricant on a photosensitive drum, and then, malfunctions may occur when printing operation is turned off. However, in the inkjet method, no such problems occur.

The first conveyor 221 includes a plurality of (in this configuration, two) rollers and a ring-shaped belt. The belt is rotationally driven by the plurality of rollers. The first conveyor 221 includes a conveyance mechanism that conveys the sheets 80 on the belt, and a supplier that delivers the topmost one of the sheets 80 placed on the sheet feed tray 211 onto the belt. The first conveyor 221 conveys the sheet 80 delivered onto the belt by the supplier by the rotation operation of the belt.

The image former 23 ejects ink onto the sheet 80, thereby forming an image on the sheet 80. The ink is, for example, UV ink. The UV ink undergoes a phase change between a gel state and a liquid (sol) state depending on the temperature in the state of not being irradiated with the UV. The UV ink has a phase change temperature of, for example, approximately 100° C., and when heated at or above the phase change temperature, the ink uniformly liquefies (transitions into a sol state). On the other hand, at or below the phase change temperature, including typical room temperatures (0° C. to 30° C.), the ink transitions into a gel state.

The image forming drum 230 carries the sheet 80 along its cylindrical outer peripheral surface, and conveys the sheet 80 by its rotation. The conveyance surface of the image forming drum 230 faces the sheet heater 231, the plurality of head modules 232, the UV irradiator 24, and the image reader 25. The sheet 80 carried and conveyed by the image forming drum 230 is subjected to processing related to image formation.

The handover section 222 is provided between the first conveyor 221 and the image forming drum 230. The handover section 222 delivers the sheet 80 conveyed by the first conveyor 221 to the image forming drum 230. The handover section includes a swing arm portion, a cylindrical handover drum, and the like. The swing arm carries one end of the sheet 80 conveyed by the first conveyor 221. The handover drum delivers the sheet 80 carried by the swing arm to the image forming drum 230. The handover section 222 picks up the sheet 80 on the conveyor 22 with the swing arm and delivers the sheet 80 to the handover drum, thereby guiding the sheet 80 in a direction along the outer peripheral surface of the image forming drum 230 to deliver the sheet 80 to the image forming drum 230.

The sheet heater 231 heats the sheet 80 carried by the image forming drum 230. The sheet heater 231 includes, for example, an infrared heater and generates heat in response to energization. The sheet heater 231 is provided in the vicinity of the outer peripheral surface of the image forming drum 230, which is upstream of the head modules 232 along the direction in which the sheet 80 is conveyed by the rotation of the image forming drum 230. The heat generation of the sheet heater 231 is controlled by the main body printer 20 (controller), such that the sheet 80 carried by the image forming drum 230 and passing through the vicinity of the sheet heater 231, reaches a predetermined temperature.

The plurality of head modules 232 ejects ink of the colors of C, M, Y, and K onto the sheet 80 carried by the image forming drum 230, thereby forming an image on the sheet 80. The head modules 232 are provided individually for each of the colors of C, M, Y, and K. In FIG. 1, the respective head modules 232 corresponding to the colors of C, M, Y, and K, are provided in this order along the conveyance direction of the sheet 80 conveyed by the rotation of the image forming drum 230.

Note that according to the present embodiment, for one color, the plurality of head modules 232 is attached to a carriage. On each carriage, the plurality of head modules is arranged in a staggered manner alternately with each other. The plurality of head modules 232 arranged on the carriage is provided, as a whole, to have a length (width) that covers the entire maximum printable width of the sheet 80 in a direction perpendicular to the conveyance direction of the sheet 80 (width direction). That is, the image former 23 is a line-head type inkjet recording apparatus employing a one-pass system. The head modules 232 can form a line head by arranging a plurality of inkjet heads (not illustrated). In addition, a retraction mechanism is connected to the carriages on which the head modules 232 are arranged, and the retraction mechanism moves the carriages and the head modules 232 included therein in the rotation axis direction of the image forming drum 230. The retraction mechanism moves the carriages to the back side in the axial direction by, for example, a distance corresponding to the maximum sheet width (several hundred millimeters (for example, 600 mm)). That is, the head modules 232 arranged on the carriages are moved to the retracted position where the head modules do not face the image forming drum 230 (or the carried sheet 80). This configuration can prevent stain (ink) from the head modules 232 from adhering to the sheet 80, and can also prevent damage to both the sheet 80 and the head modules 232 due to contact therebetween.

After the ink is ejected onto the sheet 80, the UV irradiator 24 emits an energy ray for curing the ink. The UV irradiator 24 includes, for example, a fluorescent tube such as a low-pressure mercury lamp, and emits energy rays such as ultraviolet rays, by causing the fluorescent tube to emit light. The UV irradiator 24 is provided in the vicinity of the outer peripheral surface of the image forming drum 230, which is downstream of the head modules 232 in the direction in which the sheet 80 is conveyed by the rotation of the image forming drum 230. The UV irradiator 24 irradiates the sheet 80, which is carried by the image forming drum 230 and onto which the ink is ejected, with energy rays, thereby curing the ink ejected onto the sheet 80 by the action of the energy rays.

The image reader 25 optically reads an image on a recording medium to generate image data (also referred to as read data). The image reader 25 is arranged downstream of the image former 23 on the conveyance route. The image data generated by the image reader 25 is transmitted to the image inspector 40. The image reader 25 is a sheet-feed scanner, which reads a document sheet while conveying the document sheet. The image reader 25 includes, for example, a sensor array, a lens optical system, a light emitting diode (LED) light source, and a housing that accommodates these components. The sensor array is a color or monochrome line sensor in which a plurality of optical elements (for example, charge coupled devices (CCDs)) is arranged in a line along the main scanning direction, and its reading region in the main scanning direction corresponds to the full width of a recording medium. The optical system includes a plurality of mirrors and lenses. Light from the LED light source irradiates a surface of a recording medium at a reading position. An image at the reading position is guided by the optical system and thus formed on the sensor array. The reading resolution of the image reader 25 is preferably higher than the print resolution of the image former 23. For example, when the print resolution of the image former 23 is 1200 dots per inch (dpi), the reading resolution of the image reader 25 is preferably 2400 dpi or 4800 dpi, which is higher than the print resolution.

The second conveyor 223 conveys the sheet 80 that has been irradiated with the energy ray by the UV irradiator 24, from the image forming drum 230 to the sheet ejector 26. The second conveyor 223 includes a plurality of (in this configuration, two) rollers, a ring-shaped belt, and the like. The belt is rotationally driven by the plurality of rollers. The second conveyor 223 includes a conveyance mechanism that conveys the sheet 80 on the belt, and a cylindrical handover drum that delivers the sheet 80 from the image forming drum 230 to the conveyance mechanism. The second conveyor 223 conveys, via the belt, the sheet 80 delivered by the handover drum to the belt, and sends out the sheet 80 to the sheet ejector 26.

The sheet ejector 26 stores the sheet 80 sent from the image former 23 by the second conveyor 223. The sheet ejector 26 includes a plate-shaped sheet ejection tray 261 and the like, and places the sheet 80 on which an image has been formed on the sheet ejection tray 261. Note that the sheet ejector 26 may include a purge tray in addition to the sheet ejection tray 261. The sheet 80 determined to be defective by the image inspection is ejected to the purge tray.

### (Main Body Operation Controller 30)

The main body operation controller 30 functions as a sheet setter 310, a print setter 320, a print instructor 330, an image quality adjuster 340, and a carriage operator 350 through processing through the operation display 50 or the terminal device 90. The sheet setter 310 performs setting of sheets stored in the sheet feed tray 211 according to an input by the user through the operation display 50 or the like. The setting of sheets includes, for example, the sheet type, basis weight, and sheet size.

The print setter 320 performs print setting according to an input by the user through the operation display 50 or the like. The print instructor 330 receives a print execution instruction according to the input by the user through the operation display 50 or the like. The image quality adjuster 340 starts execution of image quality adjustment according to the input by the user through the operation display 50 or the like. The carriage operator 350 activates the retraction mechanism according to the input instruction by the user to cause the carriages on which the head modules 232 are arranged to move to the retracted position or the image formation position.

### (Image Inspector 40)

The image inspector 40 includes a CPU, a RAM, a ROM, and the like. The image inspector 40 functions as a RIP image acquirer 410, a read image acquirer 420, an inspection level setter 430, a comparison inspector 440, an inspection result presenter 450, a report generator 460, and an inspection preset value setter 470. The image inspector 40 corresponds to an image inspection apparatus.

The RIP image acquirer 410 acquires a RIP image generated by the DFE 10. The read image acquirer 420 acquires a read image generated by the image reader 25. The inspection level setter 430 sets the inspection levels according to the input by the user through the operation display 50 or the like. The inspection levels that have been set are used as preset values for subsequent image inspections.

The comparison inspector 440 performs the following processes from a1 to a3.

### (Process a1) Generation of Reference Image:

In this process, one of the following Types 1 or 2 may be used as a reference image.

“Type 1” refers to the RIP image generated from the document image by being subjected to, as appropriate, various kinds of processing. Here, the various kinds of processing refers to the processing for establishing a one-to-one correspondence between pixels of the read image with pixels of the reference image, and are, for example, processing related to position, resolution, color, and the like.

“Type 2” refers to the read image obtained by reading, with the image reader 25, a user-provided printed material that has been set in the sheet feed tray 211 and conveyed. The printed material is a printed material selected from among printed materials obtained by printing the same document image (print data), which is a printed material having no image defect or a printed material in which an image defect cannot be found (hereinafter, also referred to as a correct sheet sample) when the user visually evaluates the printed material. Hereinafter, the read image obtained by reading the correct sheet sample with the image reader 25 is also referred to as a “second read image” (a first read image will be described below).

### (Relationship Between Various Samples, Reference Sample, and Inspection Sample)

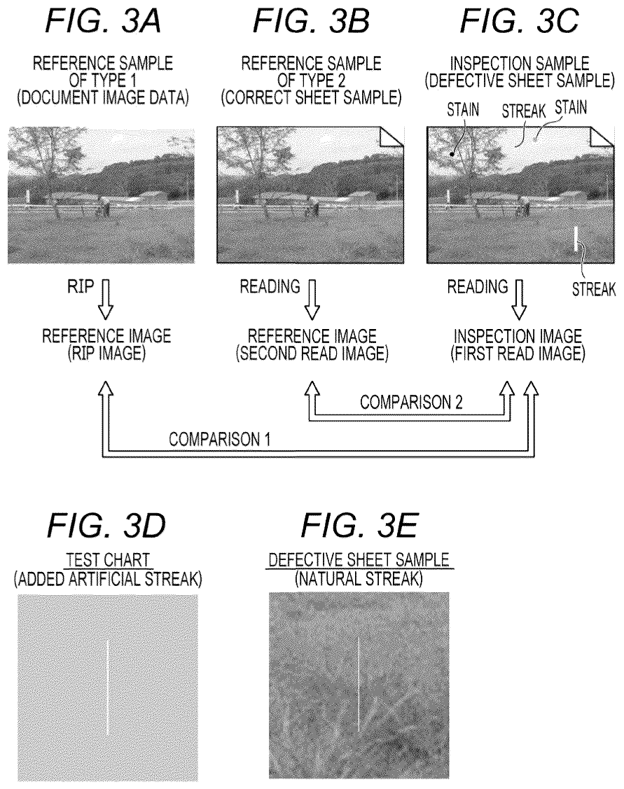

Here, the various samples, the reference sample, and the inspection sample will be described. FIG. 3A to 3E are schematic diagrams for describing a printed material. FIG. 3A illustrates Type 1. In Type 1, the document image is used as the reference sample, and a RIP image obtained by subjecting the document image to the RIP processing with the RIP 110 is used as the reference image. FIG. 3B illustrates Type 2. In Type 2, the above-described correct sheet sample is used as the reference sample, and a read image (second read image) obtained by reading, with the image reader 25, the correct sheet sample that has been fed and conveyed is used as the reference image.

FIG. 3C illustrates the inspection sample. The inspection sample is a printed material selected by the user from among a plurality of printed materials obtained by printing the document image (print data) common to FIG. 3A or 3B, which is a read image obtained by reading a printed material including an image defect. The printed material including an image defect refers to a printed material on which user content has been printed and that naturally includes an image defect, not a test chart to which a defect is intentionally added (hereinafter, also referred to as a defective sheet sample). The determination of the image defect is performed by visual evaluation or the like by the user. In the example of FIG. 3C, two streaks and two stains are present as the image defects. FIG. 3D is a diagram illustrating a test chart in which an artificial streak defect is added to a uniform halftone background as a comparative example, and FIG. 3E is a printed material on which user content has been printed and that naturally includes an image defect. In FIG. 3E, a document image of the user content has been printed on the printed material, and a natural streak has occurred therein during printing. In the inspection level setting support mode, a sample including such a natural defect as illustrated in FIG. 3E is used as the inspection sample illustrated in FIG. 3C, instead of the test chart with the artificial defect as illustrated in FIG. 3D.

The inspection sample (defective sheet sample), as illustrated in FIG. 3C, selected by the user is fed and conveyed, and a read image obtained by reading the inspection sample with the image reader 25 is used as an inspection image. The read image obtained by reading the defective sheet sample is referred to as a “first read image”.

### (Process a2) Generation of Difference Image:

The comparison inspector 440 generates a difference image by comparing the reference image and the read image (hereinafter, may also be referred to as inspection image) obtained by reading an image formed on a sheet to be inspected. Specifically, a difference (error) in pixel values is calculated for each pair of corresponding pixels between both images to obtain the difference image (image data on a per-page basis). There are two types of the comparison. In Comparison 1 using the reference sample of Type 1, the reference image of the RIP image and the inspection image are compared, and in Comparison 2 using the reference sample of Type 2, the second read image and the inspection image are compared.

In a normal image inspection mode, the sheet to be inspected is a sheet on which a RIP image of the document image has been printed. In the normal image inspection mode, a read image obtained by reading the normal printed material is the inspection target. On the other hand, in the inspection level setting support mode, the sheet to be inspected is the above-described “defective sheet sample”. In the inspection level setting support mode, a read image obtained by reading the defective sheet sample with the image reader 25 in a state where the printing operation of the image former 23 of the main body printer 20 is turned off is the inspection target.

### (Process a3) Image Defect Determination Using Inspection Levels (Preset Values):

The comparison inspector 440 analyzes the difference image and performs clustering to group pixels having a pixel value (difference pixel value) equal to or larger than a predetermined value into connected or continuous clusters. The comparison inspector 440 then compares the value of each of the clusters (hereinafter also referred to as defect candidates) with the threshold value of each inspection level to perform a pass/fail determination. In a case where the value is equal to or larger than the threshold value, it is determined to be an image defect. Types of image defects to be inspected include stains, streaks, and the like. Furthermore, a plurality of inspection settings (also referred to as setting items) is provided for each of the various image defects. For example, in the case of stains, there are items such as the size, density, edge-area sensitivity, stain allowance of reference image (see FIG. 9 to be described below).

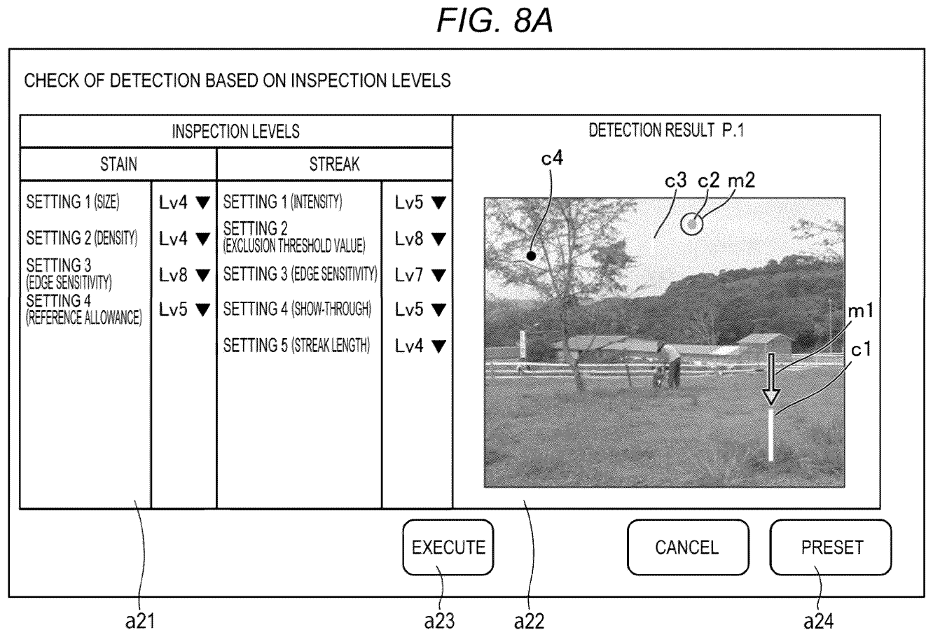

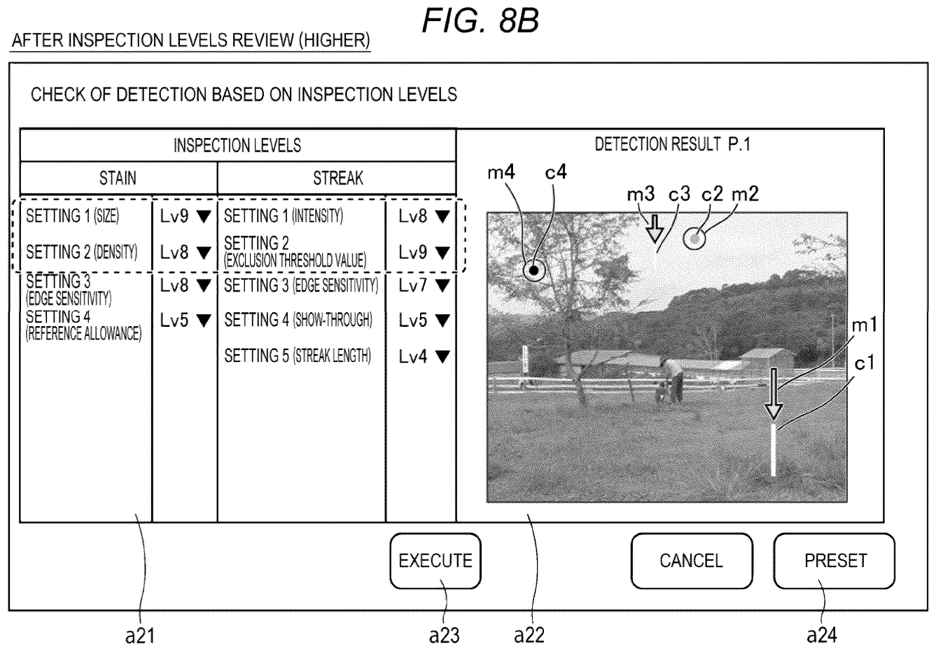

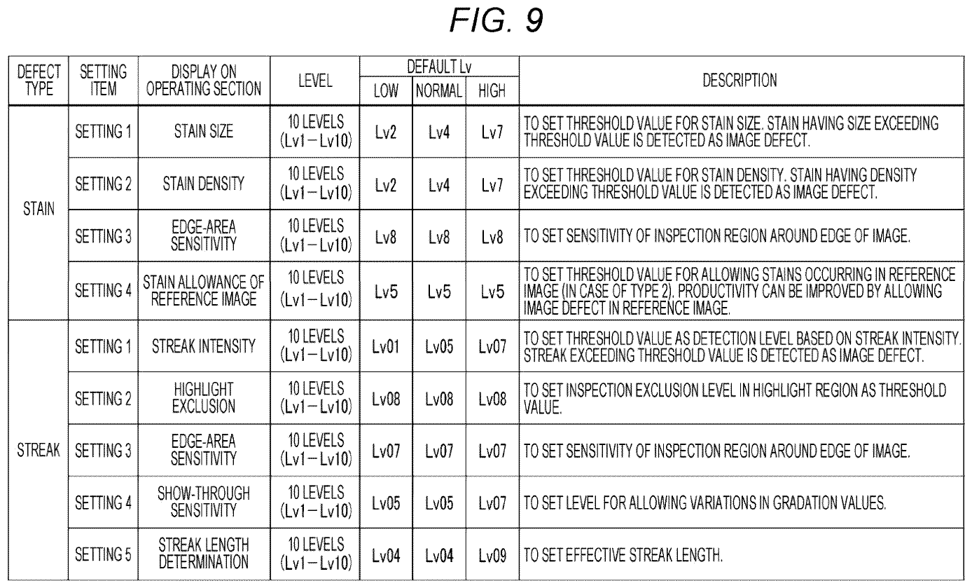

The inspection result presenter 450 presents an inspection result to the user through the operation display 50 or the like (FIG. 8A and the like to be described below). The user determines the validity of the inspection levels according to the presented inspection result.

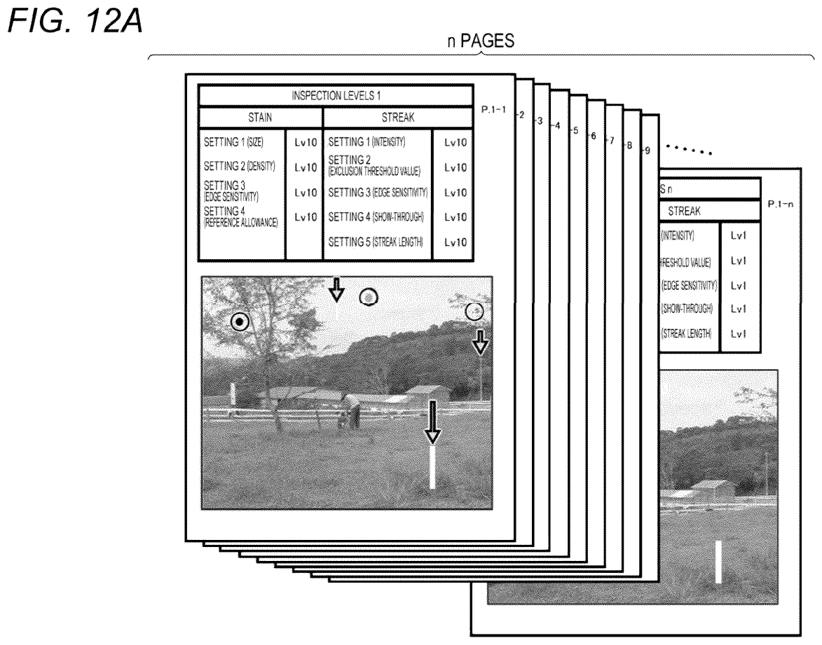

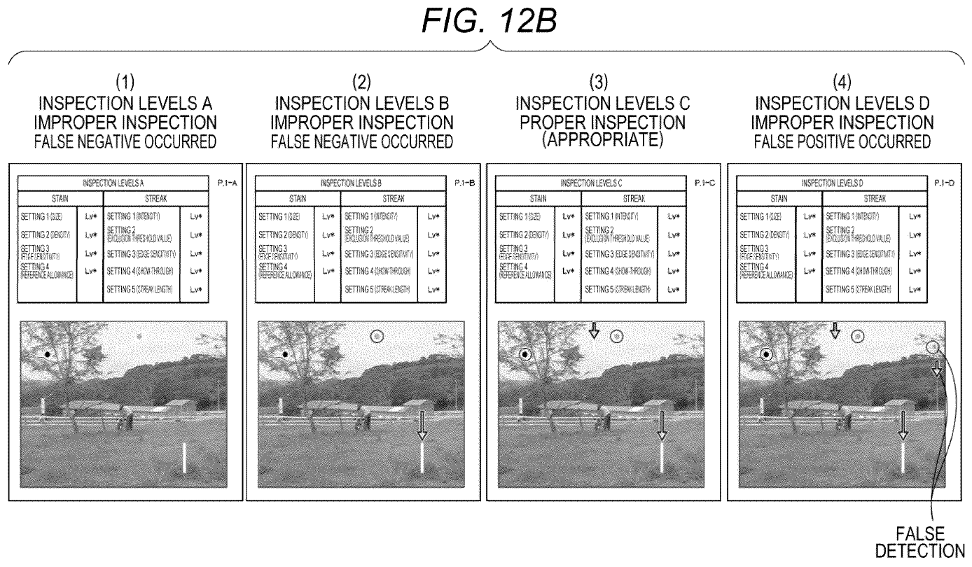

The report generator 460 generates a report in which the inspection result of the comparison inspector 440 is visualized. The report includes information indicating a read image to be inspected (image of the defective sheet sample), the presence or absence of an image defect at the inspection levels, and the type, position (in-page XY coordinates), and number of occurrences of the image defect. In addition, an annotation that surrounds the image defect or indicates the image defect with an arrow or a symbol in the vicinity thereof is added to a portion (cluster) determined as the image defect. The report is output in a PDF file format, or is converted from PDF to a file format such as jpeg and displayed on the operation display 50. An example of the report will be described below (FIG. 12A and the like).

The inspection preset value setter 470 executes the inspection level setting support mode. In the inspection level setting support mode, the inspection preset value setter 470 sets the preset values through one of the following methods of b1 or b2.
(b1) The inspection result with the current settings (preset values) of the inspection levels is presented to the user, and the determination result of the validity with the inspection levels is acquired from the user. The presentation is performed by, for example, displaying the result on the operation display 50 or a display of the terminal device 90. In addition, when receiving a change (increase or decrease/gradual or rapid) of the inspection levels from the user through the device on which the result is presented, the inspection result with the inspection levels after the change is re-presented to the user, and the determination result of the validity with the inspection levels after the change is acquired from the user. Then, in a case where a response confirming the validity is received from the user, the inspection preset value setter 470 sets the inspection levels as the preset values and cause the storage 70 to store the preset values.
(b2) The inspection results corresponding to each of a plurality of levels for the inspection levels are presented to the user together with the set values of the inspection levels.

The presentation is performed, for example, by outputting as a PDF or by printing. The user selects an inspection result with valid inspection levels from among the presented plurality of inspection results. The user transmits the selection result to the image inspection system 100 through the operation display 50 or an input section of the terminal device 90. The inspection preset value setter 470 that has received the selection result sets the inspection level (or a combination of inspection levels) as the preset value and cause the storage 70 to store the preset value.

### (Inspection Level Setting Support Mode)

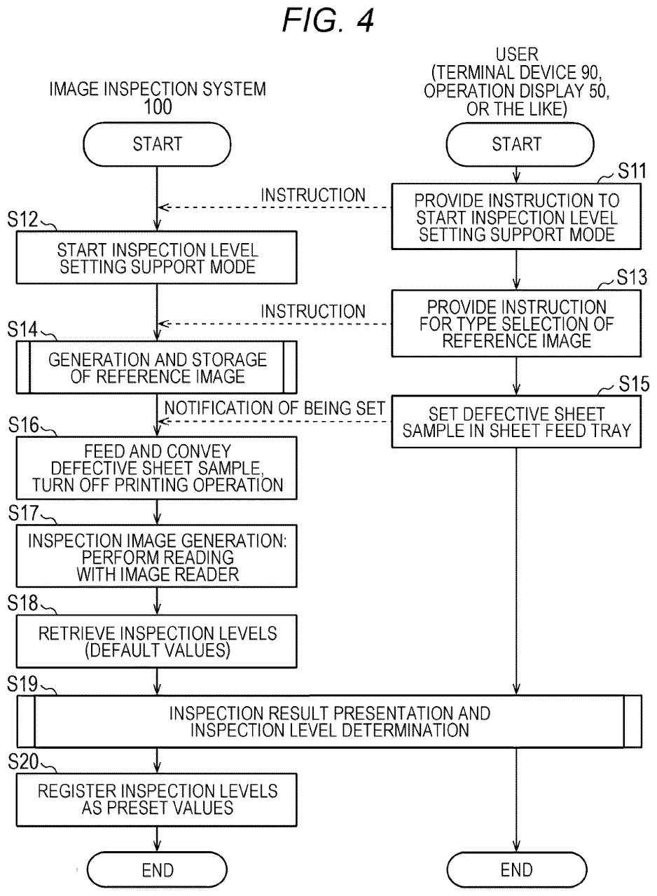

Next, the inspection level setting support mode executed by the image inspection system 100 according to the first embodiment will be described with reference to FIGS. 4 to 9.

FIG. 4 is a flowchart illustrating processing in the inspection level setting support mode.

### (Step S11)

The user provides an instruction to start the inspection level setting support mode through an operation screen of the operation display 50 or an operation screen of the web application running on the terminal device 90 (hereinafter, these are collectively referred to simply as operation screen).

### (Step S12)

The image inspection system 100 starts the inspection level setting support mode in response to the instruction.

### (Step S13)

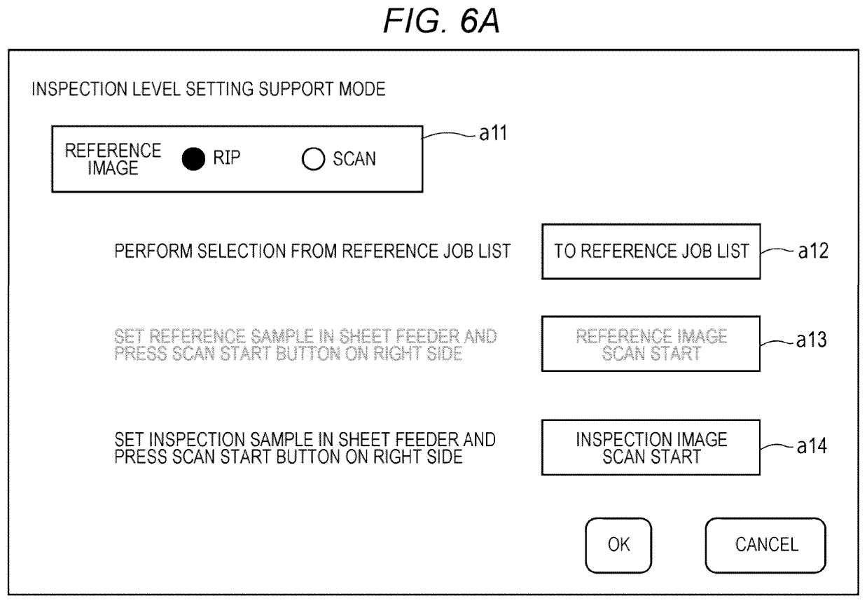

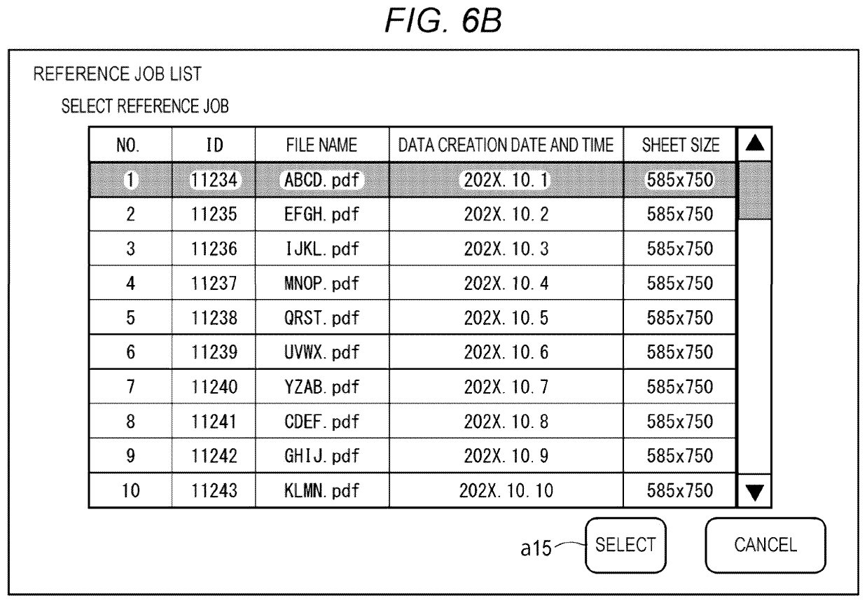

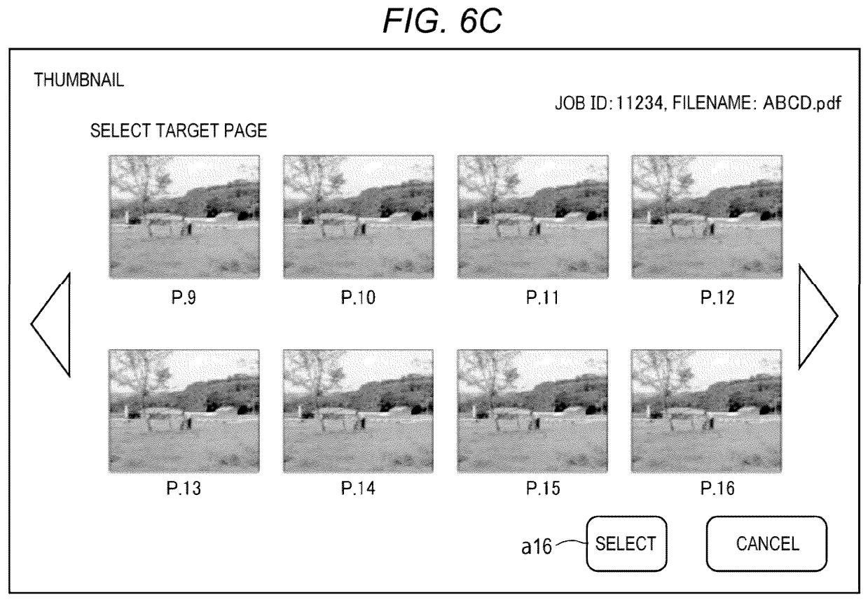

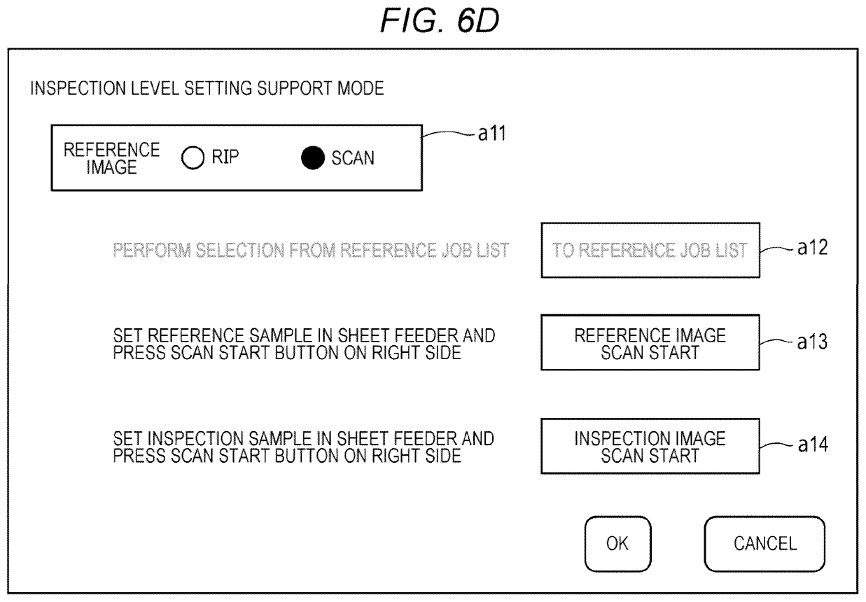

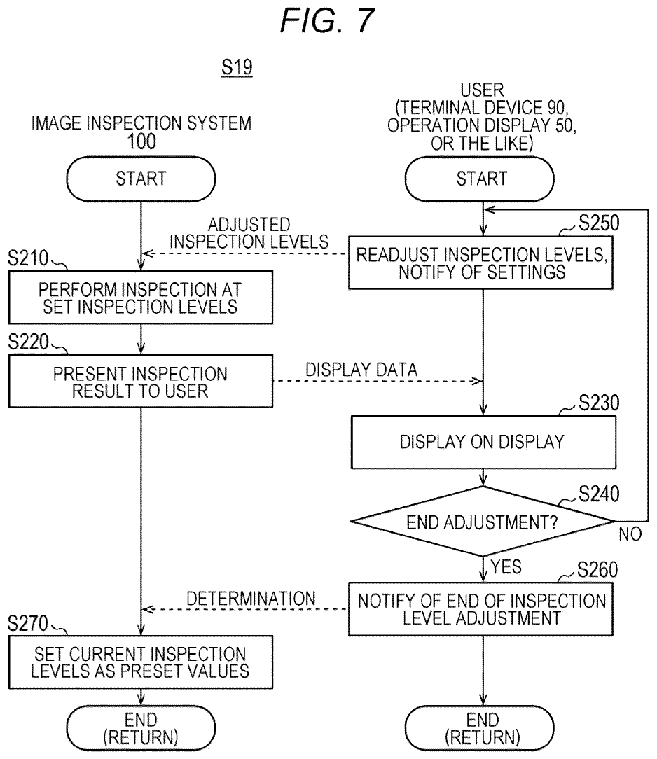

The user selects one of Types 1 or 2 of the reference image through the operation screen. FIG. 6A illustrates an example of the operation screen used in step S13 and the like. The user can select RIP or scan using radio buttons in Region a11. These correspond to respective Types 1 and 2 described with reference to FIG. 3 and the like.

### (Step S14)

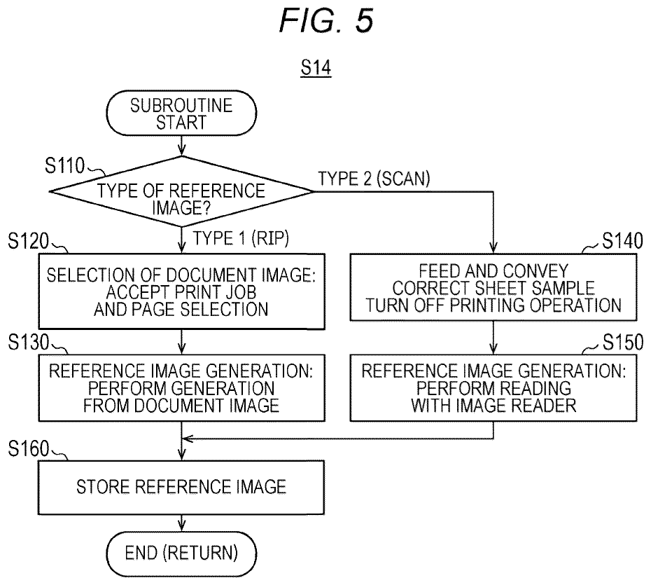

The comparison inspector 440 generates and stores the reference image. FIG. 5 is a subroutine flowchart illustrating processing in step S14.

### (Step S110)

As illustrated in FIG. 5, in the step, the comparison inspector 440 determines the type of the reference image based on the user's instruction in step S13. The comparison inspector 440 advances the process to step S120 in a case of Type 1 (RIP image) and advances the process to step S140 in a case of Type 2 (scanning method).

### (Step S120)

The comparison inspector 440 receives an instruction of selection of the document image. In the example of FIG. 6A, since the user selects “RIP” in Region a11, Region a13 is grayed out and becomes unselectable. Subsequently, the user presses a button of Region a12. Thus, the screen transitions to the operation screen illustrated in FIG. 6B. On the operation screen of FIG. 6B, the user selects a desired print job (job including the document image serving as a reference). As illustrated in FIG. 6B, selecting a row corresponding to any of print jobs and then pressing Select button a15 causes a transition to the operation screen illustrated in FIG. 6C. On the operation screen of FIG. 6C, a list of document images of a plurality of pages included in the selected print job is displayed. The user selects a desired page and then presses Select button a16 to complete the selection of the document image (image data).

### (Step S130)

The comparison inspector 440 starts generating a RIP image in response to pressing of Select button a16. In the step, the comparison inspector 440 generates the RIP image by subjecting, as appropriate, the document image selected by the user in step S120 to various kinds of processing. The RIP image is used as the reference image.

### (Step S140)

FIG. 6D illustrates an example of the operation screen used in step S140. When the user selects Scan using the radio buttons in Region a11, Region a12 is grayed out and becomes unselectable. The user sets a correct sheet sample (denoted as “reference sample” in FIG. 6D) in the sheet feed tray 211, and then presses the button of Region a13. As described above, the correct sheet sample refers to a printed material having no image defect or a printed material in which an image defect cannot be found, when the user visually evaluates the printed material.

Upon pressing the button of Region a13 as a start trigger, the correct sheet sample is fed and conveyed from the sheet feed tray 211. Note that at this time, the main body printer 20 turns off the printing operation of the image former 23. Specifically, the main body printer 20 does not operate the sheet heater 231 and the head modules 232. In addition, the UV irradiator 24 is also not operated. At this time, the main body printer 20 may further cause the retraction mechanism to move the carriages including the head modules 232 to the retracted position.

### (Step S150)

The image reader 25 reads the printed material conveyed to the reading position, that is, the correct sheet sample, to generate a read image. The read image is used as the reference image.

### (Step S160)

The comparison inspector 440 stores the reference image generated in step S130 or step S150 in the storage 70 or page memory (cache memory or the like). Then, the processing of the subroutine flowchart illustrated in FIG. 5 ends (return), and the process returns to step S14 and subsequent steps of the main flowchart illustrated in FIG. 4.

### (Step S15)

The user sets a defective sheet sample in the sheet feed tray 211. After the setting, the user presses Scanning start button a14 on the operation screen illustrated in FIG. 6A or 6D (in FIG. 6A and the like, the defective sheet sample is denoted as “inspection sample”). Here, as described above, the defective sheet sample refers to a printed material including an image defect, which is a printed material on which user content has been printed and that naturally includes an image defect, not a test chart to which a defect is intentionally added. In the case of (a) Type 1, the document image that is the source of printing of the defective sheet sample is the same as the document image that is the source of the reference image selected in step S120. Alternatively, in the case of (b) Type 2, the document image that is the source of printing of the defective sheet sample is the same as the document image that is the source of printing of the correct sheet sample set in step S140.

### (Step S16)

Upon pressing the button of Region a14 as a start trigger, the defective sheet sample is fed and conveyed from the sheet feed tray 211. Note that at this time, the main body printer 20 turns off the printing operation of the image former 23, as in step S140.

### (Step S17)

The image reader 25 reads the printed material conveyed to the reading position, that is, the defective sheet sample, to generate a read image. The read image is used as the inspection image.

### (Step S18)

The inspection level setter 430 acquires the inspection preset values from the storage 70 and sets the inspection preset values as the inspection levels. The inspection preset values herein are setting values set in the past or default setting values.

### (Step S19)

In the step, the image inspection system 100 communicates with the user, and thus inspection result presentation and inspection level determination processing to be described below are executed.

FIG. 7 is a subroutine flowchart illustrating processing in step S19 according to the first embodiment.

### (Step S210)

The comparison inspector 440 performs inspection by comparing the reference image and the inspection image at the inspection levels set so far. The reference image is generated in step S14, and the inspection image is generated based on the defective sheet sample in step S17. Note that the inspection levels used in the first inspection in step S210 (in the case of not passing through step S250) are the inspection levels acquired in step S18.

### (Steps S220 and S230)

The inspection result presenter 450 presents an inspection result to the user. FIG. 8A illustrates an example of the operation screen displayed on the operation display 50 or the terminal device 90. In the operation screen, the inspection levels of a plurality of setting items are illustrated in Region a21 with respect to the types of image defects such as stains and streaks. In addition, an inspection result with the inspection levels is presented in Region a22. FIG. 9 is an example of the types of these image defects and the setting items thereof. For example, for an image defect of stains, there are setting items of settings 1 to 4 regarding “size of stain”, “density of stain”, “edge-area sensitivity”, and “stain allowance of reference image”. In addition, for an image defect of streaks, there are setting items of settings 1 to 5 regarding “streak intensity”, “highlight exclusion”, “edge-area sensitivity”, “show-through sensitivity”, and “streak length determination”. Furthermore, for each setting item, a plurality of pre-set levels, for example, ten levels are set. The threshold values of each of the plurality of levels for an inspection level of each item are stored in the storage 70 in advance.

Here, the user can select one of three levels, for example low, normal, or high, as the default Lv. In each setting item, the greater the numerical value of the level, the stricter the determination, and the more likely defects are determined. When the level is too low, false detection (false negative) in which an image defect that is intended to be detected cannot be detected is more likely to occur. On the other hand, when the level is too high, false detection (false positive) in which a normal image is detected as defective is more likely to occur. One of the default setting levels according to the selection by the user is stored as the preset value in the storage 70. In the example illustrated in FIG. 8A, a default value “normal” is set as the preset value for the inspection level of each item.

In Region a22, a read image of the defective sheet sample, which is an inspection image to be inspected, is displayed. In the read image, defect candidates c1, c2, c3, and c4, which are clusters of difference pixels, are present. Among these defect candidates c1 to c4, the defect candidates c1 and c2 are determined to be image defects through the inspection performed by the comparison inspector 440 at the inspection levels indicated in Region a21. The defect candidates c3 and c4 are determined not to be image defects. The image defects c1 and c2 determined to be image defects are provided with annotation marks m1 and m2. The mark m1 is an arrow corresponding to a streak which is the type of image defects, and the mark m2 is a circular ring corresponding to a stain which is the type of image defects that surrounds the stain. The user can easily check the inspection result at the current inspection levels by checking the display image of the defective sheet sample presented in Region a22 on the operation screen.

(Step S240) In a case where the user is dissatisfied with the inspection result, the adjustment has not ended (NO), and the process is advanced to step S250. On the other hand, in a case where the inspection result is satisfactory, it is determined that the adjustment has ended (YES), and the process is advanced to step S260.
(step S250)

The user readjusts the inspection levels and notifies the adjusted inspection level settings. Specifically, in the operation screen illustrated in FIG. 8A, the inspection level can be changed by pulling down the downward triangle arranged beside each setting. When the user changes the level of one or more setting items and then presses Execution button a23, the adjusted settings are notified to the image inspection system 100.

### (Steps S210 to S230)

In response to the notification, the image inspection system 100 re-executes steps S210 to S230 to perform re-inspection based on the settings of the adjusted inspection levels, and presents the inspection result to the user. The user refers to the inspection result.

FIG. 8B is an example of the operation screen displayed base on the adjusted inspection level. In FIG. 8B, the settings in the area surrounded by the broken line in Region a21 are changed to higher levels, and the inspection result after the change is presented in Region a22.

In Region a22 of FIG. 8B, the read image of the defective sheet sample, which is the inspection image to be inspected, is presented. Among the defect candidates c1 to c4, in addition to the defect candidates c1 and c2, the defect candidates c3 and c4 are also determined to be image defects through the inspection performed by the comparison inspector 440 at the inspection levels indicated in Region a21. Accordingly, the image defects c3 and c4 are also provided with annotation marks m3 and m4.

### (Step S260)

When the user determines to end the adjustment (when satisfied with the inspection level settings for the current inspection result), the user presses Preset button a24, and thus the image inspection system 100 is notified accordingly.

### (Step S270)

Upon receiving the notification, the inspection preset value setter 470 sets the current inspection levels as the preset values. Then, the processing of the subroutine flowchart illustrated in FIG. 7 ends (return), and the process returns to step S19 and subsequent steps of the main flowchart illustrated in FIG. 4.

### (Step S20)

The inspection preset value setter 470 registers the inspection levels as the preset values in the storage 70, and ends the process (END).

As described above, the present embodiment includes an inspection level setting support mode in which a printed material which is a sheet on which a content has already been printed, set in a sheet feeder and fed from the sheet feeder is conveyed to the conveyance route, and the threshold value for the inspection level is set by detecting an image defect based on a first read image obtained by reading the printed material with an image reader in a state where printing operation of an image former is turned off. In addition, in the inspection level setting support mode, the plurality of levels for an inspection level, each having a different threshold value is set in advance. A plurality of inspection results corresponding to each of the plurality of levels for the inspection level is presented to a user, and the threshold value of the inspection level used in an inspection result selected by the user from among the inspection results that have been presented is registered as a preset value to be used for inspection. Thus, the inspection level can be appropriately set by setting the threshold value of the inspection level using the printed material in which a defect has actually occurred.

### (Normal Image Inspection Mode)

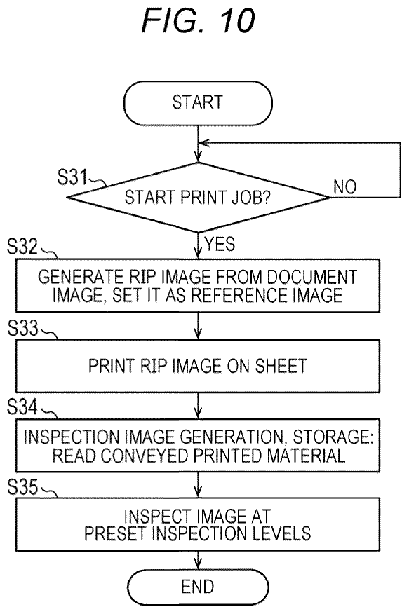

Next, the normal image inspection mode executed by the image inspection system 100 will be described with reference to FIG. 10. In the normal image inspection mode, an image is inspected using the preset values registered through the processing in the inspection level setting support mode illustrated in FIG. 4 and the like described above.

### (Step S31)

When receiving a print job from the user through the operation display 50, the terminal device 90, or the like, the image inspection system 100 starts the print job (YES). The data of the received print job includes the print data (document image) and the print settings.

### (Step S32)

The RIP 110 generates a RIP image from the document image based on the print settings of the print job. In addition, the RIP image acquirer 410 of the image inspector 40 acquires the RIP image and uses it as the reference image.

### (Step S33)

The main body printer 20 performs printing on a sheet fed from the sheet feed tray 211, based on the RIP image.

### (Step S34)

The image reader 25 reads an image on the sheet on which the image is formed as an inspection target to generate a read image. The read image acquirer 420 of the image inspector 40 acquires the read image and uses it as an inspection image.

### (Step S35)

The comparison inspector 440 acquires the preset values for the inspection levels from the storage 70. In addition, the image is inspected by performing the image defect determination ((a3) described above) using the inspection levels (preset values). When one or more image defects are found through the image inspection, the sheet (printed material) is determined to be defective and is discharged to the purge tray. The above processing is performed until the print job is completed (end).

The above describes the processing in the normal image inspection mode. In the normal image inspection mode, the image inspector 40 continuously conveys the sheets 80, and while forming images on the sheets, performs the image inspection by using the read image obtained by reading with the image reader 25 arranged on the downstream side on the conveyance route. In this case, in the normal image inspection mode, the maximum allowable processing time is limited to a cycle of the sheets 80 continuously conveyed. For example, when the printing speed is 3000 sheets/hour, the maximum allowable processing time is 1.2 seconds per sheet. There is no such a restriction in the above-described inspection level setting support mode, so that the processing time of the inspection level setting support mode is longer than the “maximum allowable processing time” in the normal image inspection mode.

### Second Embodiment

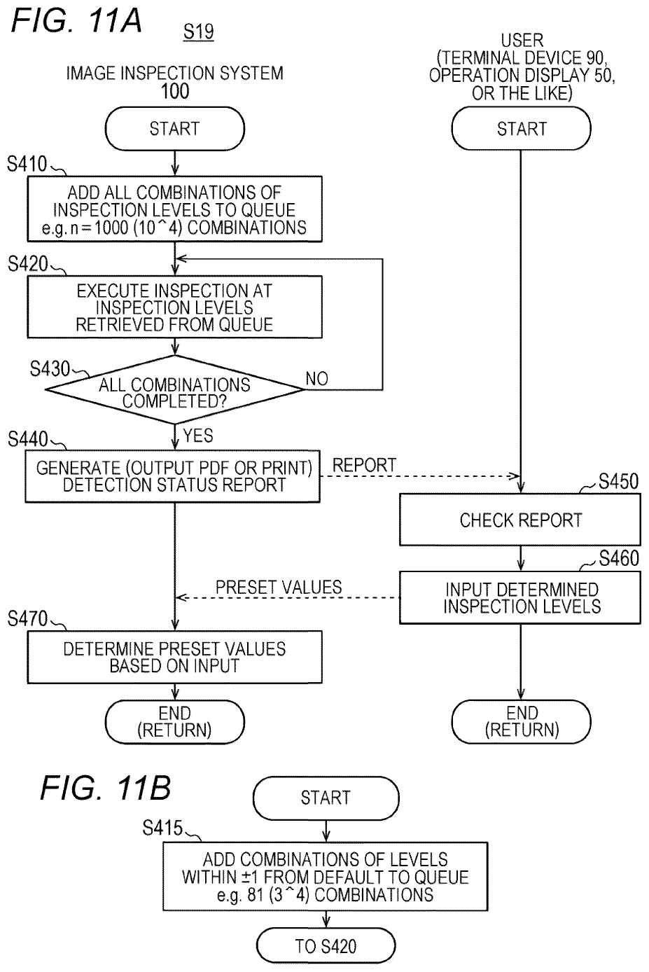

Next, the inspection level setting support mode according to the second embodiment will be described with reference to FIGS. 11A, 11B, 12A and 12B. According to the above-described first embodiment, the presentation of the inspection result to the user is performed by displaying the inspection result on the display (FIG. 8A and the like). According to the second embodiment, the presentation of the inspection result to the user is performed by outputting a report of the inspection result, as described below.

FIG. 11A is a subroutine flowchart illustrating processing in step S19 of FIG. 4 according to the second embodiment.

### (Step S410)

The inspection preset value setter 470 of the image inspector 40 adds all combinations of the inspection levels to the queue. For example, in a case where the type of image defects is stain, the number of the inspection level setting items is four and each of the setting items can be set in ten levels, the total number of combinations is n=1000 (=10\hat{ }4). The inspection preset value setter 470 adds, for example, 1000 combinations to the queue. Note that in this case, the inspection preset value setter 470 may use a fixed value to prevent the value from varying for some settings. For example, in the example illustrated in FIG. 9, in Setting 3 (edge sensitivity) and Setting 4 (reference allowance) of Stain, in which the default Lv remains unchanged across low, normal, and high levels, fixed values may be used. In this case, the total number of combinations is n=100 (=10²).

FIG. 11B is a partial modification example of FIG. 11A. Step S410 of FIG. 11A may be modified like Step S415 illustrated in FIG. 11B. In step S415, with the default as a reference, combinations of levels within±1 from the default are added to the queue. Each default is indicated in FIG. 9. For example, when “normal” is selected as the default, each setting item is changed in three levels of the default value, the default value+1, and the default value−1, instead of the ten levels. In this case, with four setting items and three levels, the total number of combinations is n=81 (=3\hat{ }4), and an excessive increase in the number of inspection results can be suppress, accordingly.

### (Step S420)

The comparison inspector 440 retrieves one combination of the inspection levels from the queue and executes inspection under the retrieved condition. The inspection here is the same as that in step S210 described above, except that different inspection levels are used.

### (Step S430)

When all the combinations have not been completed (NO), the inspection preset value setter 470 repeats the processing of step S420, and when all the combinations have been completed (YES), the inspection preset value setter 470 advances the process to step S440.

### (Step S440)

The report generator 460 generates an inspection result report in which respective combinations of inspection levels and the corresponding inspection results are described. In addition, the image inspector 40 transmits the generated report to the user. The report is output by transmitting PDF files or by printing onto sheets. FIG. 12A illustrates an example of inspection result outputs presented to the user according to the second embodiment. In FIG. 12A, one PDF page file is output for each combination of the inspection levels as the report, resulting in n pages in total.

FIG. 12B is a diagram extracting the contents of four pages with different combinations of inspection levels from among the n pages of FIG. 12A. In FIG. 12B (1), the inspection levels are too low (the numerical values are small), causing false detection. No image defect is detected in FIG. 12B (1). In FIG. 12B (2), the inspection levels are slightly low, causing false detection. In FIG. 12B (2), some image defects can be detected, but some image defects cannot be detected. In FIG. 12B (3), defects are properly detected. In FIG. 12B (4), the inspection levels are too high, causing false detection (false positive). In FIG. 12B (4), a portion that is not an image defect is determined to be an image defect.

### (Step S450 and S460)

The user checks the output report and selects a combination of the inspection levels at which a desired inspection result has been obtained. For example, a combination of the inspection levels with the lowest level condition is selected from among the combinations with which the desired inspection result (inspection levels C) is obtained. The user inputs the selected combination through the operation screen. For example, in the example of the FIG. 12B, the user inputs a number (for example, inspection levels C) described on the page, with which the desired inspection result is obtained.

### (Step S470)

The inspection preset value setter 470 determines the preset values based on the input. For example, when the inspection levels C is input, the inspection level (for each inspection item) corresponding to the inspection levels C indicated in FIG. 12B is determined as the preset value.

As described above, in the second embodiment, the presentation to the user is performed by outputting the inspection result as the report. With the configuration described above, the similar effects to those of the first embodiment can be obtained.

### Third Embodiment

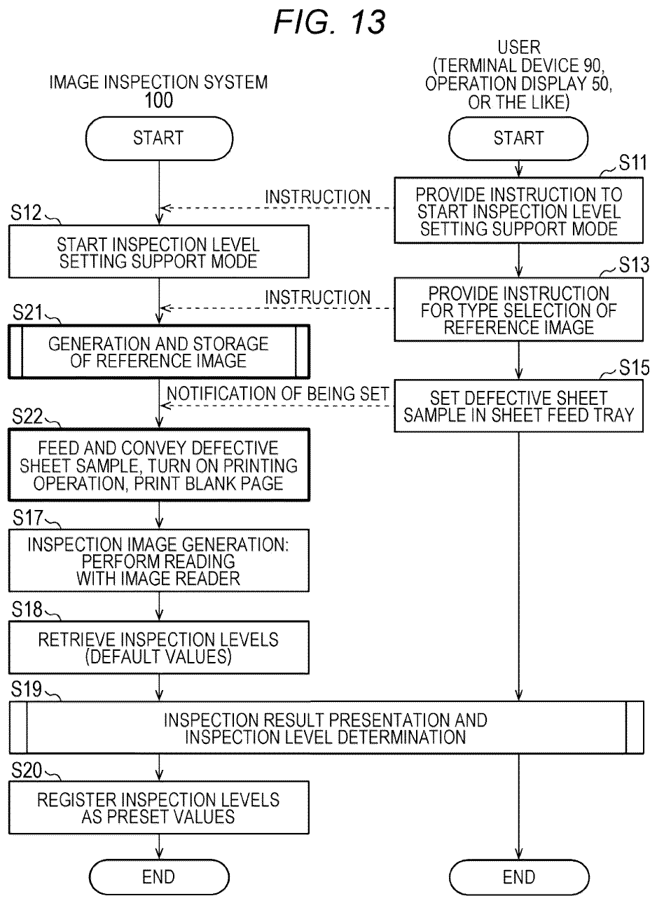

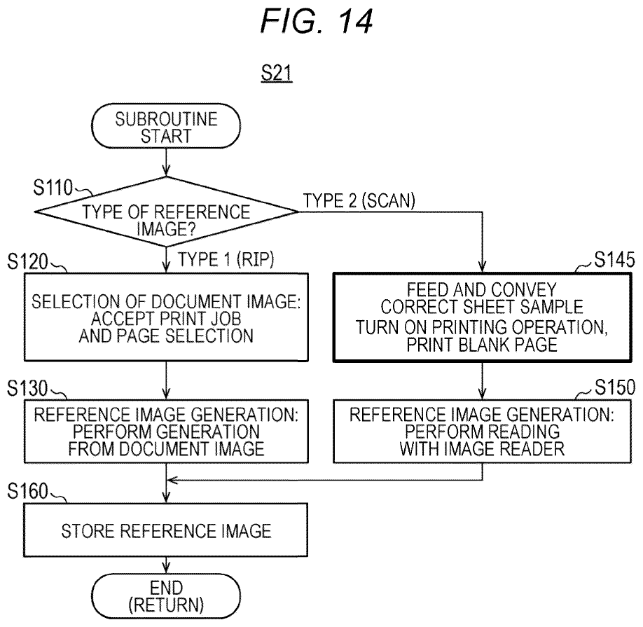

Next, the inspection level setting support mode according to the third embodiment will be described with reference to FIGS. 13 and 14. In each of the above-described embodiments such as the first embodiment, the printing operation is turned off in the inspection level setting support mode. In the third embodiment, a blank page is printed without turning off the printing operation. Here, the blank page means that there is substantially no image, that is, the document image on which no image or almost no image is drawn.

FIG. 13 is a flowchart illustrating processing in the inspection level setting support mode according to a third embodiment. FIG. 14 is a subroutine flowchart illustrating processing in step S21 illustrated in FIG. 13. In FIG. 13, all steps other than steps S21 and S22 correspond directly to those in FIG. 4. Similarly, in FIG. 14, all steps other than S145 correspond directly to those in FIG. 5. Corresponding processing is denoted by the same step number, and description thereof is omitted.

### (Steps S11 to S13)

The processing performed so far are the same as that in steps S11 to S13 in FIG. 4.

### (Step S21)

In step S21, the comparison inspector 440 generates and stores the reference image. FIG. 14 is a subroutine flowchart illustrating processing in step S21.

### (Step S110 and S145)

In a case of Type 2 (scanning method), the comparison inspector 440 advances the process to step S145. The processing in a case of Type 1 (RIP image) is the same as that in FIG. 4 according to the first embodiment, and the description thereof is omitted.

In step S145, the user sets the correct sheet sample in the sheet feed tray 211. Then, the button in Region a13 in FIG. 6D is pressed. Upon pressing the button of Region a13 as a start trigger, the correct sheet sample is fed and conveyed from the sheet feed tray 211. Note that at this time, the main body printer 20 turns on the printing operation of the image former 23, unlike the first embodiment. Specifically, the main body printer 20 operates the sheet heater 231, the head modules 232, the UV irradiator 24, and the like. At this time, the image inspector 40 causes a blank page to be printed as the document image. That is, no additional image is printed on the correct sheet sample.

(step S120, S130, S150 and S160)

The processing is the same as that in FIG. 5, and the description thereof is omitted. The comparison inspector 440 stores the reference image generated in step S150 in the storage 70 or page memory (cache memory or the like). Then, the processing of the subroutine flowchart illustrated in FIG. 14 ends (return), and the process returns to step S21 and subsequent steps of the main flowchart illustrated in FIG. 13.

### (Step S22)

As illustrated in FIG. 13, in this step, the defective sheet sample that is set on the sheet feed tray 211 by the user in step S15, is fed and conveyed. At this time, the main body printer 20 turns on the printing operation of the image former 23, as in step S145. At this time, the image inspector 40 causes a blank page to be printed as the document image, as in step S145. That is, no additional image is printed on the defective sheet sample.

### (Steps S17 to S20)

In step S17, the image reader 25 reads the printed material conveyed to the reading position, that is, the defective sheet sample, to generate a read image. The read image is used as the inspection image. The processing in the subsequent steps S17 to S20 is as described in FIG. 4. The image inspector 40 presents the respective inspection results at the plurality of different inspection levels to the user, and the user selects a desired inspection result from among the inspection results. Then, the inspection preset value setter 470 registers the threshold values of the inspection levels used in the selected inspection result as the preset values to be used for inspection.

In the third embodiment as described above, the similar effects to those of the first or second embodiment can also be obtained.

The configurations of the image inspection system 100 and the inspection level setting support method executed by the devices included therein described above are merely main configurations for describing the features of the embodiments described above, are not limited to the configurations described above, and can be modified in various manners within the scope of the claims.

For example, in a case where the image inspector 40 functions as an image inspection apparatus, it may be arranged on the terminal device 90.

In addition, means and methods for performing the various processes in the image inspection system 100 according to the above-described embodiments can be implemented by any of a dedicated hardware circuit and a programmed computer. The program may be provided by, for example, a computer-readable recording medium such as a USB memory or a digital versatile disc (DVD)-ROM, or may be provided online via a network such as the Internet. In this case, the program recorded on the computer-readable recording medium is usually transferred to and stored in a storage such as a hard disk. In addition, the program may be provided as independent application software, or may be incorporated into software of an apparatus as one function of the apparatus.

Although the embodiments of the present invention have been described and illustrated in detail, the disclosed embodiments have been created for purposes of illustration and example only, and not limitation. The scope of the present invention is to be interpreted by the wording of the appended claims.

What is claimed is:

1. An image inspection system comprising:
a sheet feeder;
an image former that forms an image on a sheet fed and conveyed from the sheet feeder; and
an image reader that is arranged downstream of the image former on a conveyance route along which the sheet is conveyed and reads the image on the sheet, wherein
the image inspection system detects an image defect using a threshold value for an inspection level set using a read image generated by reading with the image reader, and
the image inspection system includes an inspection level setting support mode in which a printed material which is a sheet on which a content has already been printed, set in the sheet feeder and fed from the sheet feeder is conveyed to the conveyance route, and the threshold value for the inspection level is set by detecting an image defect based on a first read image obtained by reading the printed material with the image reader in a state where printing operation of the image former is turned off.

2. The image inspection system according to claim 1, wherein the content is user content, not a test chart, including an image defect.

3. The image inspection system according to claim 2, wherein a RIP image of the user content is set as a reference image, the first read image is set as an inspection image, and an image defect is detected by comparison inspection between the inspection image and the reference image.

4. The image inspection system according to claim 2, wherein using, as a correct sheet sample, a printed material with no image defect, among printed materials obtained by printing a RIP image of the user content with the image former, the correct sheet sample set in the sheet feeder is fed and conveyed from the sheet feeder, a second read image obtained by reading the correct sheet sample with the image reader in a state where printing operation of the image former is turned off, is set as a reference image, the first read image is set as an inspection image, and an image defect is detected by comparison inspection between the inspection image and the reference image.

5. The image inspection system according to claim 3, wherein a plurality of levels for an inspection level, each having a different threshold value is set in advance, a plurality of inspection results corresponding to each of the plurality of levels for the inspection level is presented to a user, and an inspection level used in an inspection result selected by the user from among the inspection results that have been presented is registered as a preset value to be used for inspection.

6. The image inspection system according to claim 5, wherein a plurality of setting items is provided for one image defect type, a plurality of levels for an inspection level is set for each of the setting items in advance, inspection is executed with a combination of the inspection levels of the plurality of setting items, and an inspection result based on the combination of the inspection levels of the plurality of setting items is presented to the user.

7. The image inspection system according to claim 6, wherein presentation to the user is performed by displaying on a display.

8. The image inspection system according to claim 6, wherein presentation to the user is performed by outputting the inspection result as a report.

9. The image inspection system according to claim 5, wherein a normal image inspection mode is executed, in which an image defect is detected by comparison inspection between a reference image generated based on a RIP image of print data of a print job and an inspection image which is a read image obtained by reading, with the image reader, a printed material obtained by printing the RIP image with the image former using the preset value as the inspection level.

10. The image inspection system according to claim 9, wherein a processing time in the inspection level setting support mode is longer than a maximum allowable processing time in the normal image inspection mode.

11. The image inspection system according to claim 1, wherein the image former is an inkjet-method image former that forms an image by ejecting ink onto a sheet from a nozzle of a head module.

12. The image inspection system according to claim 11, wherein the image former moves a carriage on which the head module is installed to a retracted position at which the carriage does not face the sheet, when the inspection level setting support mode is executed.

13. An image inspection apparatus that detects an image defect using a threshold value of an inspection level set using a read image generated by reading with an image reader that is arranged downstream of an image former on a conveyance route along which a sheet is conveyed and reads an image on the sheet, comprising an inspection level setting support mode in which a printed material on which user content including an image defect, not a test chart, has been printed, set in a sheet feeder is fed and conveyed from the sheet feeder, and the threshold value of the inspection level is set by detecting an image defect based on a first read image obtained by reading the printed material with the image reader in a state where printing operation of the image former is turned off.

14. An inspection level setting support method for image inspection that is executed in an image inspection system comprising a sheet feeder, an image former that forms an image on a sheet fed and conveyed from the sheet feeder, and an image reader that is arranged downstream of the image former on a conveyance route along which the sheet is conveyed and reads the image on the sheet, that detects an image defect using a threshold value of an inspection level set using a read image generated by reading with the image reader, the inspection level setting support method comprising:
a step of feeding and conveying, from the sheet feeder, a printed material on which user content including an image defect, not a test chart, has been printed, set in the sheet feeder;
a step of printing blank page data including substantially no image as a document image of a print job on the printed material in a state where printing operation of the image former is activated in a normal printing state; and
a step of setting the threshold value of the inspection level by detecting an image defect based on a read image obtained by reading the printed material with the image reader.
